(19) United States
(12) Patent Application Publication
(10) Pub. No.: US 2017/0308244 A1
(43) Pub. Date: Oct. 26, 2017

(54) TOUCH DISPLAY PANEL

(71) Applicant: EVERDISPLAY OPTRONICS (SHANGHAI) LIMITED, Shanghai (CN)

(72) Inventors: Wei Sheng SU, SHANGHAI (CN); Tianwang HUANG, SHANGHAI (CN)

(73) Assignee: EVERDISPLAY OPTRONICS (SHANGHAI) LIMITED, SHANGHAI (CN)

(21) Appl. No.: 15/218,289

(22) Filed: Jul. 25, 2016

(30) Foreign Application Priority Data
Apr. 22, 2016 (CN) 201610257030.X

(51) Int. Cl. G06F 3/042

(52) U.S. Cl. CPC G06F 3/0421; G06F 2203/04106

(57) ABSTRACT

The present disclosure relates to a touch display panel. The touch display panel includes: a substrate including at least one first region and at least one second region which are disposed as adjacent to each other; a plurality of touch display units disposed on the substrate, wherein each of the plurality of touch display units includes: a driving element disposed in one of the at least one first region; an optical sensing member disposed in one of the at least one second region; a display device disposed on the driving element and the optical sensing member and electrically connected with the driving element; and a reflection layer disposed on the display device; wherein the optical sensing member is configured to sense light which is emitted from the display device to the reflection layer and reflected by reflection layer so as to sense a touch position.

### CROSS-REFERENCE TO RELATED APPLICATIONS

This application claims priority to Chinese Patent Application No. 201610257030.X, filed Apr. 22, 2016, the entire contents of which are incorporated herein by reference.

### TECHNICAL FIELD

The present disclosure generally relates to display technologies, and more particularly to, a touch display panel.

### BACKGROUND

Because of properties like human-machine interactions, touch display panels have gradually replaced keyboards and been widely applied in a variety of fields such as electronic devices. Recently, consumer electronics have been extensively developed, and accordingly the structures and forms of touch display panels have become diverse.

The existing touch display panels can be generally classified into two types depending on the integration of touch elements and display panels: one type is in-cell touch display panel in which touch elements are directly provided in a display panel; and the other type is on-cell touch display panel in which the touch elements are provided at an outer surface of a display panel.

The on-cell type touch display panels are confronted with difficulties in thinning of products. The in-cell type touch display panels have complicated linear process manner and are difficult to manufacture, and because the touch elements are provided in the display panels, usually below cathodes which have an impact on the touch sensing of the touch elements, the touch performance of the in-cell type touch display panels can be influenced.

### SUMMARY

Aiming at the shortcomings in conventional technologies, embodiments of the present disclosure provide a touch display panel which is capable of avoiding the influence resulted from the cathode of the display device and has good touch performance.

An aspect of embodiments of the present disclosure provides a touch display panel, including:

a substrate including at least one first region and at least one second region which are disposed as adjacent to each other;

a plurality of touch display units disposed on the substrate, wherein each of the plurality of touch display units includes:

a driving element disposed in the at least one first region;

an optical sensing member disposed in the at least one second region:

a display device disposed on the driving element and the optical sensing member and electrically connected with the driving element; and

a reflection layer disposed on the display device;

wherein the optical sensing member is configured to sense light which is emitted from the display device to the reflection layer and reflected by reflection layer so as to sense a touch position.

According to an exemplary embodiment, the optical sensing member includes:

a first metal layer disposed in the at least one second region of the substrate;

a first semiconductor layer disposed on the first metal layer; and

a second metal layer disposed on the first semiconductor layer.

According to an exemplary embodiment, the optical sensing member further includes a first insulation layer disposed on the first semiconductor layer as adjacent to the second metal layer.

According to an exemplary embodiment, the first semiconductor layer is formed by a poly-silicon material or indium gallium zinc oxide material.

According to an exemplary embodiment, the driving element includes:

a gate disposed in the at least one first region of the substrate;

a gate insulation layer disposed on the gate;

a second semiconductor layer disposed on the gate insulation layer and overlapping with at least a part of the gate in a direction perpendicular to the substrate;

a first insulation layer disposed on the second semiconductor layer and provided with a first through hole and a second through hole therein; and

a source and a drain disposed on the first insulation layer and electrically connected with the second semiconductor layer via the first through hole and the second through hole, respectively.

According to an exemplary embodiment, the display device includes:

a first electrode electrically connected with the drain;

a light-emitting layer disposed on the first electrode;

a pixel defining layer disposed on the first electrode around the light-emitting layer and overlapping with at least a part of the at least one second region in the direction perpendicular to the substrate; and

a second electrode disposed on the light-emitting layer and the pixel defining layer.

According to an exemplary embodiment, the touch display panel further includes a passivation layer disposed between the display device and the driving element and between the display device and the optical sensing member, and the display device is electrically connected with the driving element by passing through the passivation layer.

According to an exemplary embodiment, the touch display panel further includes a planarized layer disposed between the passivation layer and the display device, and the display device is electrically connected with the driving element by passing through the passivation layer and the planarized layer.

According to an exemplary embodiment, the touch display panel further includes a buffer layer disposed on the substrate and located between the driving element and the substrate and between the optical sensing member and the substrate.

According to an exemplary embodiment, the touch display panel further includes a buffer layer disposed on the substrate and located between the driving element and the substrate and between the optical sensing member and the substrate.

According to an exemplary embodiment, the touch display panel further includes a glass cover plate disposed at a side of the reflection layer away from the reflection layer.

The technical solutions provided by embodiments of the present disclosure can have the following advantageous effects over conventional technologies. In the touch display panels provided by embodiments of the present disclosure, an optical sensing member is provided between a substrate and a display device. The optical sensing member, based on the principles of thermoelectric conversion, senses the light which is emitted from the display device to a reflection layer and is then reflected by the reflection layer. When the light arrives at the optical sensing member, current occurs, and whether a user is performing touch at the position where the touch display unit is located can be determined by detecting the changes of the current, and thereby the touch position of the user on the touch display panel can be determined. By using the touch display panels in the present disclosure, problems existing in conventional in-cell type touch display panels that the touch performance can be influenced by cathodes of display devices can be avoided. Thus, the touch display panels in the present disclosure have better touch performance. Further, the touch display panel can be applied in bendable display panels. Even when the thicknesses of touch display panels become thinner and thinner, the touch performance will become better, which accords with the current development trend of touch display panels.

### BRIEF DESCRIPTION OF THE DRAWINGS

Other features, objectives and advantages of the present disclosure will become clearer from the following detailed description regarding non-restrictive embodiments with reference to drawings.

FIG. 1 is a cross-sectional view of a touch display panel according to an embodiment of the present disclosure.

FIG. 2 shows paths of emitted light from a display device according to an embodiment of the present disclosure before a touch display unit is touched by a finger.

FIG. 3 shows paths of emitted light in a display device according to an embodiment of the present disclosure after a touch display unit is touched by a finger.

### DETAILED DESCRIPTION

Now, exemplary implementations will be described more comprehensively with reference to the accompanying drawings. However, the exemplary implementations may be carried out in various manners, and shall not be interpreted as being limited to the implementations set forth herein; instead, providing these implementations will make the present disclosure more comprehensive and complete and will fully convey the conception of the exemplary implementations to the ordinary skills in this art. Throughout the drawings, the like reference numbers refer to the same or the like structures, and repeated descriptions will be omitted.

The features, structures or characteristics described herein may be combined in one or more embodiments in any suitable manner. In the following descriptions, many specific details are provided to facilitate sufficient understanding of the embodiments of the present disclosure. However, one of ordinary skills in this art will appreciate that the technical solutions in the present disclosure may be practiced without one or more of the specific details, or by employing other methods, components, materials and so on. In other conditions, well-known structures, materials or operations are not shown or described in detail so as to avoid confusion of respective aspects of the present disclosure.

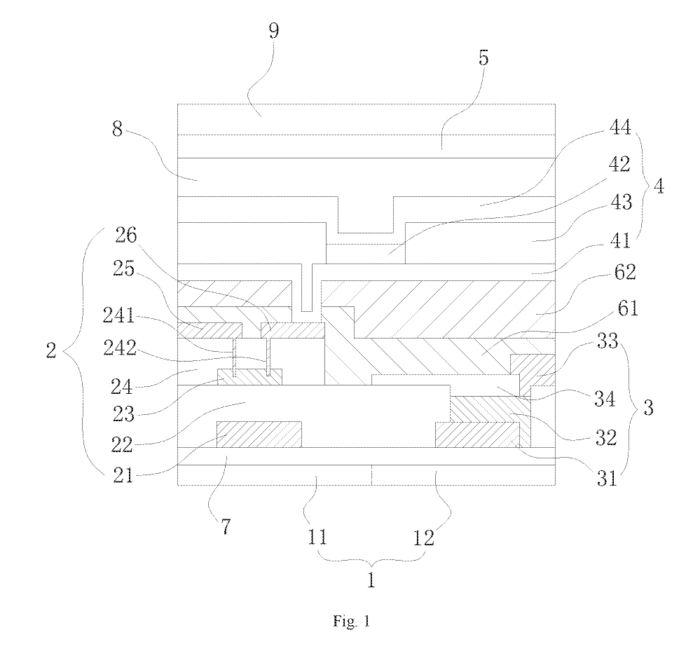

FIG. 1 is a cross-sectional view of a touch display panel according to an embodiment of the present disclosure. In the embodiment, the touch display panel includes a substrate 1 and a plurality of touch display units which are disposed on the substrate 1. The substrate 1 includes at least one first region 11 and at least one second region 12. In FIG. 1, the structure of the touch display panel is described taking an example of one of the touch display units. As shown in FIG. 1, each of the touch display units includes a driving element 2, an optical sensing member 3, a display device 4 and a reflection layer 5.

The driving element 2 is disposed in the at least one first region 11 of the substrate 1, and is located between the substrate 1 and the display device 4 and electrically connected with the display device 4. The driving element 2 includes a gate 21, a gate insulation layer 22, a second semiconductor layer 23, a first insulation layer 24, a source 25 and a drain 26. In the embodiment as shown in FIG. 1, the driving element 2 may have a bottom gate structure, for example. Specifically, the gate 21 is disposed in one of the first regions 11 on the substrate 1. The gate insulation layer 22 is disposed on the gate 21, covering the gate 21. The second semiconductor layer 23 is disposed on the gate insulation layer 22, and overlaps with at least a part of the gate 21 in a direction perpendicular to the substrate 1. The first insulation layer 24 is disposed on the second semiconductor layer 23, covering the second semiconductor layer 23. A first though hole 241 and a second through hole 242 are provide in the first insulation layer 24.

The source 25 is disposed on the first insulation layer 24, and electrically connected with the second semiconductor layer 23 via the first through hole 241. The drain 26 is disposed on the first insulation layer 24, and electrically connected with the second semiconductor layer 23 via the second through hole 242.

The optical sensing member 3 is disposed in the at least one second region 12 of the substrate 1, and is located between the substrate 1 and the display device 4. The optical sensing member 3 is used for sensing the light which is emitted from the display device 4 to the reflection layer 5 and is then reflected by the reflection layer 5 so as to sense the touch position. Specifically, the optical sensing member 3 includes a first metal layer 31, a first semiconductor layer 32 and a second metal layer 33.

The first metal layer 31 is disposed in the at least one second region 12 of the substrate 1. In the embodiment as shown in FIG. 1, the first metal layer 31 and the gate 21 can be in the same layer, which means that the first metal layer 31 and the gate 21 can be manufactured at the same time (i.e., the first metal layer 31 and the gate 21 are formed in the same step). The first metal layer 31 and the gate 21 are separated from each other by the gate insulation layer 22.

The first semiconductor layer 32 is disposed on the first metal layer. The first semiconductor layer 32 can be formed using a material which is the same as that of the second semiconductor layer 23, for example, poly-silicon material or indium gallium zinc oxide material, and thereby the first semiconductor layer 32 and the second semiconductor layer 23 can be manufactured at the same time (i.e., first semiconductor layer 32 and the second semiconductor layer 23 can be formed in the same step). After the light emitted from the display device 4 arrives at the second semiconductor layer 23 after being reflected by the reflection layer 5, photocarriers occur in the second semiconductor layer 23 to change the resistance of the second semiconductor layer 23, and thereby current can be generated by irradiating PN junction by means of light (this is similar to the power generation principle of solar cells). When the touch display unit is touched by a finger of a user, the reflection property of the reflection layer 5 changes, and then the generated current changes. As a result, the touch display panel can sense the touch position of the finger.

The second metal layer 33 is disposed on and electrically connected with the first semiconductor layer 32. The second metal layer 33 and the source 25 and the drain 26 can be formed by the same material, and thereby the second metal layer 33 and the source 25 and the drain 26 can be formed at the same time during the manufacturing process.

Further, in the embodiment as shown in FIG. 1, the optical sensing member 3 further includes a first insulation layer 34. The first insulation layer 34 is disposed on the first semiconductor layer 32. Specifically, the first insulation layer 34 covers the upper surface of the first semiconductor layer 32, and the second metal layer 33 is electrically connected with the first semiconductor layer 32 by passing through the first insulation layer 34.

The display device 4 is disposed at one side of the substrate 1. Specifically, the display device 4 includes a first electrode 41, a light-emitting layer 42, a pixel defining layer 43 and a second electrode 44. As shown in FIG. 1, the first electrode 41 is disposed on the driving element 2 and the optical sensing member 3. The first electrode 41 is electrically connected with the drain 26. The light-emitting layer 42 is disposed on the first electrode 41. The pixel defining layer 43 is disposed on the first electrode 41 around the light-emitting layer 42, and overlaps with at part of the one of the at least one second region 12 of the substrate 1. The second electrode 44 is disposed on the light-emitting layer 42 and the pixel defining layer 43.

The reflection layer 5 is disposed at a side of the display device 4 away from the substrate 1. As shown in FIG. 1, the reflection layer 5 is disposed on the display device 4, and thus can reflect a part of the light emitted from the display device 4 to the optical sensing member 3. The reflection layer 5 can be made of materials such as indium tin oxide.

Further, in the embodiment as shown in FIG. 1, the touch display panel may further include a passivation layer 61. As shown in FIG. 1, the passivation layer 61 is disposed on the optical sensing member 3 and the driving element 2, and is located between the display device 4 and the driving element 2 and between the display device 4 and the optical sensing member 3. The first electrode 41 of the display device 4 is electrically connected with the drain 26 of the driving element 2 by passing through the passivation layer 61.

Further, in the embodiment as shown in FIG. 1, the touch display panel may further include a planarized layer 62. The planarized layer 62 is disposed on the passivation layer 61 and is located between the passivation layer 61 and the display device 4. The first electrode 41 of the display device 4 is electrically connected with the drain 26 of the driving element 2 by passing through the passivation layer 61 and the planarized layer 62.

Further, in the embodiment as shown in FIG. 1, the touch display panel may further include a buffer layer 7. The buffer layer 7 is disposed on the substrate 1, and is located between the driving element 2 and the substrate 1 and between the optical sensing member 3 and the substrate 1. That is, the gate 21 and the gate insulation layer 22 of the driving element 2 and the first metal layer 31 and the first semiconductor layer 32 of the optical sensing member 3 are disposed on the buffer layer 7.

Further, in the embodiment as shown in FIG. 1, the touch display panel may further include a package layer 8. The package layer 8 is disposed between the reflection layer 5 and the display device 4 for preventing moisture from invading into the display device 4. The package layer 8 can be formed by alternately depositing inorganic thin film layers and organic thin film layers.

Further, in the embodiment as shown in FIG. 1, the touch display panel may further include a glass cover plate 9. The glass cover plate 9 is disposed at a side of the reflection layer 5 away from the substrate 1. As shown in FIG. 9, the glass cover plate 9 is disposed on the reflection layer 5 to protect the touch display panel.

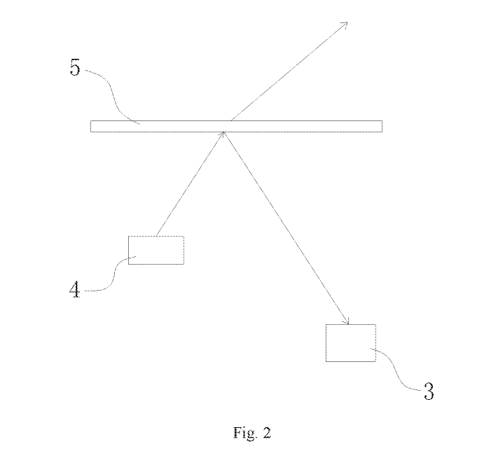

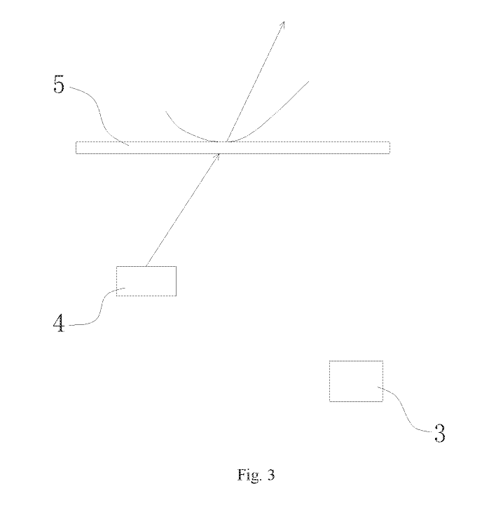

FIGS. 2 and 3 show paths of emitted light from the display device according to an embodiment of the present disclosure before and after the touch display unit is touched by a finger, respectively. As shown in FIG. 2, when the finger does not reach the position where the touch display unit is located, the light emitted from the display device 4 arrives at the reflection layer 5. A part of the light is refracted and then goes towards a light-out side of the reflection layer 5 (i.e., the upper side of the reflection layer 5) for displaying. Another part of light is reflected by the reflection layer 5 and then goes towards the optical sensing member 3, photocarriers are generated in the second semiconductor layer 23 of the optical sensing member 3 to change the resistance of the second semiconductor layer 23, and thereby current is generated by irradiating PN junction by means of light (this is similar to the power generation principle of solar cells). When the finger touches the position where the touch display unit is located, as shown in FIG. 3, the light emitted from the display device 4 and arriving at the reflection layer 5 is refracted and then goes towards the light-out side of the reflection layer 5 (i.e., the upper side of the reflection layer 5). Under such condition, the intensities of the refracted light and reflected light change. Accordingly, the current generated in the second semiconductor layer 23 of the optical sensing member 3 changes. The touch display panel can determine whether the finger of the user touches the position where the touch display unit is located according to the changes of the current generated in the second semiconductor layer 23 of the optical sensing member 3.

In view of the above, in the touch display panels provided by embodiments of the present disclosure, an optical sensing member is provided between a substrate and a display device. The optical sensing member, based on the principles of thermoelectric conversion, senses the light which is emitted from the display device to a reflection layer and is then reflected by the reflection layer. When the light arrives at the optical sensing member, current occurs, and whether a user is performing touch at the position where the touch display unit is located can be determined by detecting the changes of the current, and thereby the touch position of the user on the touch display panel can be determined. By using the touch display panels in the present disclosure, problems existing in conventional in-cell type touch display panels that the touch performance can be influenced by cathodes of display devices can be avoided. Thus, the touch display panels in the present disclosure have better touch performance. Further, the touch display panel can be applied in bendable display panels. Even when the thicknesses of touch display panels become thinner and thinner, the touch performance will become better, which accords with the current development trend of touch display panels.

While the present disclosure is described with reference to some exemplary embodiments, these exemplary embodiments are not for limiting the present disclosure. One of ordinary skill in this art can make various changes, amendments, substitutions, and modifications without departing from the spirit and scope of the present disclosure. Thus, the protection scope of the present disclosure shall be defined by appended claims.

What is claimed is:

1. A touch display panel, comprising:
a substrate comprising at least one first region and at least one second region which are disposed as adjacent to each other;
a plurality of touch display units disposed on the substrate, wherein each of the plurality of touch display units comprises:
a driving element disposed in the at least one first region;
an optical sensing member disposed in the at least one second region:
a display device disposed on the driving element and the optical sensing member and electrically connected with the driving element; and
a reflection layer disposed on the display device;
wherein the optical sensing member is configured to sense light which is emitted from the display device to the reflection layer and reflected by reflection layer so as to sense a touch position.

2. The touch display panel according to claim 1, wherein the optical sensing member comprises:
a first metal layer disposed in the at least one second region of the substrate;
a first semiconductor layer disposed on the first metal layer; and
a second metal layer disposed on the first semiconductor layer.

3. The touch display panel according to claim 2, wherein the optical sensing member further comprises a first insulation layer disposed on the first semiconductor layer as adjacent to the second metal layer.

4. The touch display panel according to claim 2, wherein the first semiconductor layer is formed by a poly-silicon material or indium gallium zinc oxide material.

5. The touch display panel according to claim 2, wherein the driving element comprises:
a gate disposed in the at least one first region of the substrate;
a gate insulation layer disposed on the gate;
a second semiconductor layer disposed on the gate insulation layer and overlapping with at least a part of the gate in a direction perpendicular to the substrate;
a first insulation layer disposed on the second semiconductor layer and provided with a first through hole and a second through hole therein; and
a source and a drain disposed on the first insulation layer and electrically connected with the second semiconductor layer via the first through hole and the second through hole, respectively.

6. The touch display panel according to claim 5, wherein the display device comprises:
a first electrode electrically connected with the drain;
a light-emitting layer disposed on the first electrode;
a pixel defining layer disposed on the first electrode around the light-emitting layer and overlapping with at least a part of the one of the at least one second region in the direction perpendicular to the substrate; and
a second electrode disposed on the light-emitting layer and the pixel defining layer.

7. The touch display panel according to claim 1, wherein the touch display panel further comprises a passivation layer disposed between the display device and the driving element and between the display device and the optical sensing member, and the display device is electrically connected with the driving element by passing through the passivation layer.

8. The touch display panel according to claim 7, wherein the touch display panel further comprises a planarized layer disposed between the passivation layer and the display device, and the display device is electrically connected with the driving element by passing through the passivation layer and the planarized layer.

9. The touch display panel according to claim 1, wherein the touch display panel further comprises a buffer layer disposed on the substrate and located between the driving element and the substrate and between the optical sensing member and the substrate.

10. The touch display panel according to claim 2, wherein the touch display panel further comprises a buffer layer disposed on the substrate and located between the driving element and the substrate and between the optical sensing member and the substrate.

11. The touch display panel according to claim 3, wherein the touch display panel further comprises a buffer layer disposed on the substrate and located between the driving element and the substrate and between the optical sensing member and the substrate.

12. The touch display panel according to claim 4, wherein the touch display panel further comprises a buffer layer disposed on the substrate and located between the driving element and the substrate and between the optical sensing member and the substrate.

13. The touch display panel according to claim 1, wherein the touch display panel further comprises a package layer disposed between the reflection layer and the display device.

14. The touch display panel according to claim 2, wherein the touch display panel further comprises a package layer disposed between the reflection layer and the display device.

15. The touch display panel according to claim 3, wherein the touch display panel further comprises a package layer disposed between the reflection layer and the display device.

16. The touch display panel according to claim 4, wherein the touch display panel further comprises a package layer disposed between the reflection layer and the display device.

17. The touch display panel according to claim 1, wherein the touch display panel further comprises a glass cover plate disposed at a side of the reflection layer away from the substrate.

18. The touch display panel according to claim 2, wherein the touch display panel further comprises a glass cover plate disposed at a side of the reflection layer away from the substrate.

19. The touch display panel according to claim 3, wherein the touch display panel further comprises a glass cover plate disposed at a side of the reflection layer away from the substrate.

20. The touch display panel according to claim 4, wherein the touch display panel further comprises a glass cover plate disposed at a side of the reflection layer away from the substrate.
